(19) United States
(12) Patent Application Publication
(10) Pub. No.: US 2006/0232565 A1
(43) Pub. Date: Oct. 19, 2006

(54) Electronic media reader that splits into two pieces

(76) Inventor: Arthur L. Drevnig, Toronto (CA)

Correspondence Address: Arthur Drevnig, 57 Ranee Avenue, Toronto, ON, M6A 1M8, CA

(21) Appl. No.: 11/401,373

(22) Filed: Apr. 11, 2006

Related U.S. Application Data
(60) Provisional application No. 60/670,013, filed on Apr. 11, 2005.

(51) Int. Cl. G09G 5/00

(52) U.S. Cl. 345/173

(57) ABSTRACT

The inventive device is an electronic media reader that allows the user to experience text, graphics, video and audio. The device also includes a method to separate the heavy portions from the physical display portion. The two pieces are tethered together to allow for power and communication. This serves to reduce the weight of the piece that the user is required to hold. The device also includes both wireless and wired electronic communications capabilities that allow it to receive and transmit data. For power, the unit may be powered by battery or via power cable.

### REFERENCES

NOTE: This non-provisional application references the following previously submitted provisional application:

Provisional Application No. 60/670,013

### U.S. PATENT DOCUMENTS CITED

U.S. Pat. No. 6,525,706 February 2003 Rehkemper

U.S. Pat. No. 5,893,132 April 1999 Huffman

U.S. Pat. No. 5,991,594 November 1999 Froeber

U.S. Pat. No. 5,897,324 April 1999 Tan

U.S. Pat. No. 5,761,485 June 1998 Munyan

U.S. Pat. No. 5,534,888 July 1996 Lebby

U.S. Pat. No. 5,477,510 December 1995 Ukita

U.S. Pat. No. 5,652,606 July 1997 Sasaki

U.S. Pat. No. 5,924,068 July 1999 Richard

U.S. Pat. No. 5,970,231 October 1999 Crandall

### BACKGROUND OF THE INVENTION

1. Field of the Invention

The present invention relates generally to an electronic media reader and relates specifically to the ability to separate that unit into two pieces to minimize the weight that the user is required to hold while viewing the content.

2. Description of the Prior Art

It can be appreciated that portable display units of different types have been available for years in different varieties—laptop computers, electronic book readers, etc. However, these existing devices have focused on improvements by reducing the weight of the device through lighter battery technologies and lighter electronics. While useful, it would be of more use to split the heavy portions away entirely.

As specified in U.S. Pat. No. 6,525,706 to Rehkemper, various forms of electronic books have been provided in the past. Such as:

U.S. Pat. No. 5,893,132 to Huffman discloses a method for encoding a textual book for use with an electronic book. U.S. Pat. No. 5,991,594 to Froeber discloses a device that receives cards that contain a unique text permanently stored therein and displays the text on an LCD screen. U.S. Pat. No. 5,897,324 to Tan specifically discloses an electronic book that permits reception of varying input cards such that different books may be viewed.

U.S. Pat. No. 5,761,485 to Munyan discloses an electronic book that can receive and transmit information over wireless mediums. The book, providing displays opposite each other, like facing pages, allows the user to enter information via touch sensitive screens. The electronic book also includes memory capacity to store multiple books or publications.

U.S. Pat. No. 5,534,888 to Lebby discloses an electronic book, which in one embodiment includes a plurality of pages that provide flexible screens simulating the pages of a book. The book further includes the means to receive downloads and display other books and information.

U.S. Pat. No. 5,477,510 to Ukita discloses an apparatus, which can display information or images stored on an optical disc. The display may further be manipulated with a pen to enter information using a displayed keyboard. The Ukita apparatus attempts to make electronic books thinner by stacking the keyboard within the LCD display.

U.S. Pat. No. 5,652,606 to Sasaki discloses an electronic newspaper and electronic publishing medium. The electronic newspaper can be placed in the medium in order to download the current news, which may be displayed and searched. The downloaded information may also include books, advertisements, magazines or periodicals.

U.S. Pat. No. 5,924,068 to Richard discloses a messaging service, which will allow an apparatus to receive the newspaper, edit the same, and convert the text to speech. The speech is thereafter sent to an audible output signal for the user to listen rather than read the paper.

Furthermore, U.S. Pat. No. 5,970,231 to Crandall discloses a portable electronic newspaper that is battery operated along with an associated central data exchange.

However, all of these above-mentioned prior art references, fail to provide a device that separates into two pieces in order to reduce the weight born by the user's hands.

### SUMMARY OF THE INVENTION

It is an object of the present invention to provide an electronic media reader which overcome the drawbacks of the prior art.

This new reader is extremely portable. Splitting the heavy portions from the main display area allows these weighty portions to be placed in nearby areas such as on a nearby table, in a backpack or on the user's waist. These heavy portions may include the battery, the power supply, much of the computer electronics and the hard drive.

The unit itself includes the latest modern computer technology and also encompasses a color, touch-sensitive screen and can be powered by battery or line voltage. Furthermore, data connectivity can be accomplished by either high speed cable, DSL, WiFi, WiMax or other high speed wireless connectivity.

The content supported includes text, images, video and sound. Naturally, the device includes associated software to decode the aforementioned content and display it clearly.

The content itself would be produced and delivered by existing producers including but not limited to those currently producing newspapers, magazines and books.

### BRIEF DESCRIPTION OF THE DRAWINGS

FIG. 1 shows a detailed view of the hand-held portion of the system.

FIG. 2 shows an overall diagram of the system.

FIG. 3 shows a possible cable distribution strategy using satellite communications to feed cable head ends.

FIG. 4 shows a possible Internet-based distribution strategy. Example interfaces to the system could be via cable modem connection, DSL connection or wireless connection (e.g. WiFi, WiMax, GSM, CDMA, TDMA)

FIG. 5 shows a possible distribution strategy where the user simply inserts a memory card containing new content.

### DETAILED DESCRIPTION OF THE INVENTION

Turning now descriptively to the drawings, in which similar reference characters denote similar elements throughout the several views, the attached figures illustrate an electronic media reader device.

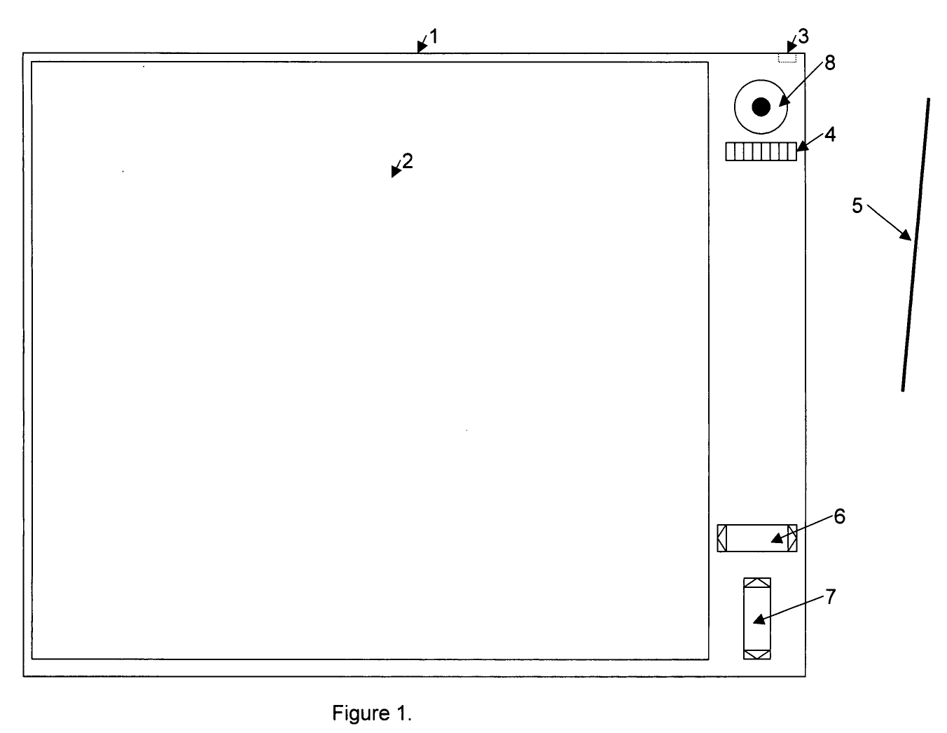

FIG. 1 shows the main portion of the unit that a user holds. The unit 1 is similar width to tabloid-sized newspapers and is designed to fit comfortably in the hands. It contains touch-sensitive screen 2 where stylus 3 is used to interact with the content. Sample uses for stylus 3 include but are not limited to scrolling vertically or horizontally and clicking on hyperlinks to navigate the content. Physical scroll buttons 6 and 7 can also be used to scroll through the content. For audio, the unit also includes a speaker 8 and a physical volume knob 4. Stylus 5 is designed to fit into the unit for storage via stylus opening 3.

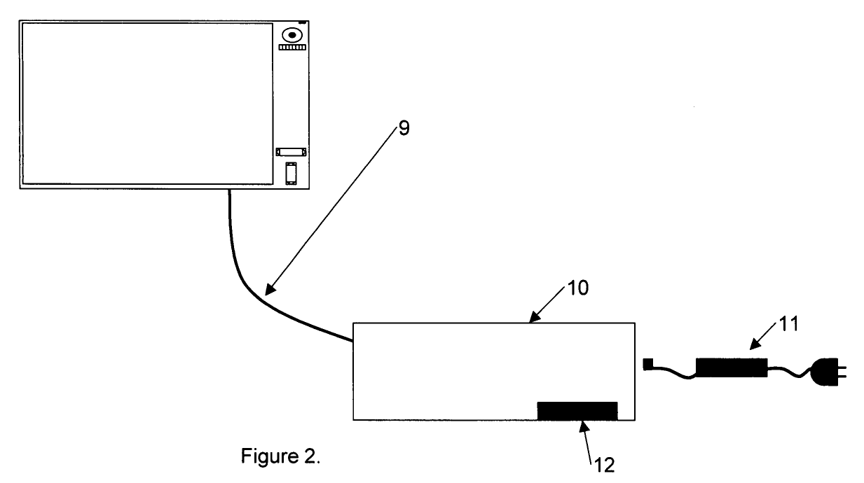

FIG. 2 shows a more holistic view of the apparatus. The main portion of the unit shown in FIG. 1 is attached via a flexible wire tether 9 to portion 10 where the heavy parts (such as batteries, disk drives, CPU electronics, etc.) are located. The heavy parts are placed in portion 10 to as large a degree as possible recognizing that some components must be in close proximity to the screen. Furthermore, wire tether 9 is required to provide both physical rigidity and strain relief as well as communications. While not shown in the figure, portion 1 and portion 10 can be locked together mechanically to allow for easy carrying of the device or use of the device.

This unit is designed with expansion slot 12 which allows for networking connections, memory additions and future expansion options. Power is provided via rechargeable batteries inside portion 10 which receive their power from power cord 11 which connects to a commonly-available power source.

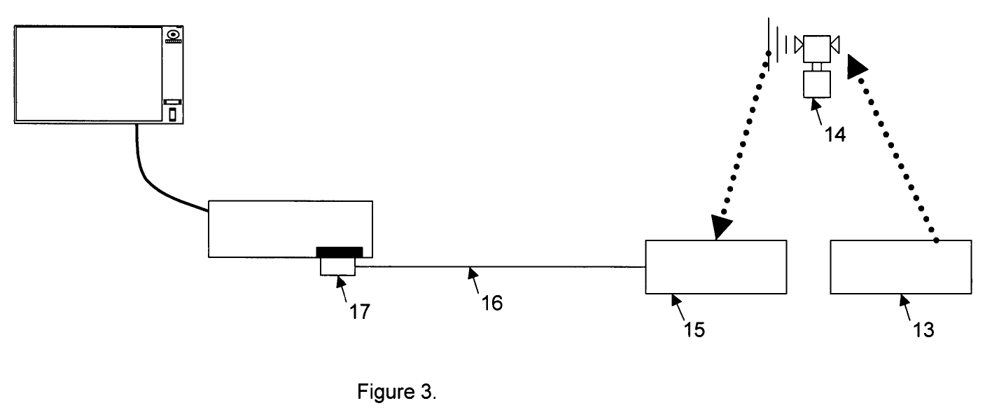

FIG. 3. shows a possible distribution scheme using the cable television coaxial cable plant system and whereby a server at location 13 transmits content via satellite 14 to cable head-end 15. The signal is then transmitted via the coaxial cable 16 to any specific example of the electronic media reader connected to the cable via cable modem 17.

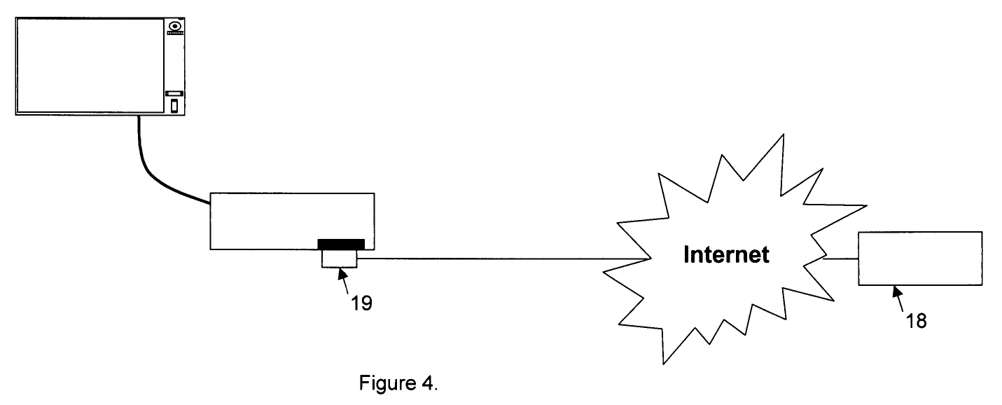

FIG. 4. shows a possible distribution scheme using the Internet and whereby a server at location 18 is linked via the Internet and over any network to the electronic media reader via an Internet connection 19. Note that in this scheme, the data could either be “pushed” to multiple electronic media readers simultaneously or could be “pulled” from individual electronic media readers one by one. In this case, to minimize traffic requirements, each electronic media reader would connect to the server at a randomly generated time.

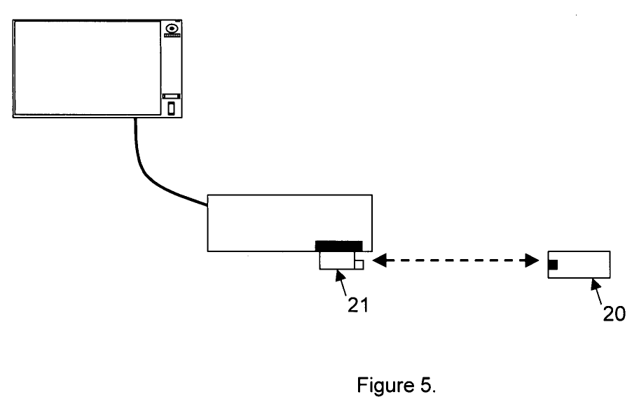

FIG. 5. shows a possible distribution scheme using memory cards (for example USB-based memory cards) to transport the content. Cards 21, containing the desired content would be connected to the unit via a connector 20 which itself inserts into expansion slot 12.

We claim:

1. An electronic media reader comprising:
two portions including portion #1 with
a portable outer casing of strong, light-weight material that is the approximate width of modern tabloid newspapers such that it can be held comfortably with two hands;
a flat-panel, touch sensitive display screen;
a speaker combined with associated volume dial;
rocker buttons for navigation side-to-side and up-and-down;
a stylus for touch screen activation;
and separately portion #2 with:
a portable outer casing of strong, light-weight material encasing the heavy electronics—including but not limited to batteries, power supply, CPU and display circuits and storage and hard drive electronics, associated with the said electronic newspaper reader; this portion of the device also includes an expansion slot for networking connections, memory additions and future expansion options.

2. the electronic media reader of claim 1 further comprising: a flexible wire tether which includes cables for physical rigidity, support and strain relief as well as for power and data connectivity between the two separate portions mentioned in claim 1 whose separation serves to connect the heavy portions of the electronic media reader from the display and user interface portions; this design results in a new and improved system wherein the improvement comprises the ability to separate the heavy portions from the light and make reading the material displayed much lighter and easier on the users' arms.

3. the electronic media reader of claim 2 further comprising:
a methodology for mechanically locking together the two portions of the electronic media reader to allow for easy carrying or use of the device.
